(19) United States
(12) Patent Application Publication
(10) Pub. No.: US 2024/0233169 A1
(43) Pub. Date: Jul. 11, 2024

(54) WATER INUNDATION DEPTH DETERMINATION PROGRAM, WATER INUNDATION DEPTH DETERMINATION DEVICE, AND WATER INUNDATION DEPTH DETERMINATION METHOD

(71) Applicant: FUJITSU LIMITED, Kawasaki-shi (JP)

(72) Inventors: Kazuhiro MATSUMOTO, Kawasaki (JP); Hiroyuki HIGUCHI, Hino (JP); Shun KOHATA, Setagaya (JP); Katsumi HOMMA, Kawasaki (JP); Fumiyasu MAKINOSHIMA, Mitaka (JP)

(73) Assignee: FUJITSU LIMITED, Kawasaki-shi (JP)

(21) Appl. No.: 18/611,148

(22) Filed: Mar. 20, 2024

Related U.S. Application Data
(63) Continuation of application No. PCT/JP21/35440, filed on Sep. 27, 2021.

(51) Int. Cl. G06T 7/70; G06V 10/764; G06V 20/50; G06V 20/70

(52) U.S. Cl. CPC G06T 7/70; G06V 10/764; G06V 20/50; G06V 20/70; G06T 2207/20081; G06T 2207/20084; G06T 2207/30184; G06T 2207/30196; G06V 2201/08

(57) ABSTRACT

A non-transitory computer-readable recording medium storing a water inundation depth determination program for causing a computer to execute processing including: detecting a first type of a target and a first submersion position of the target included in a first captured image; and outputting a first submersion depth corresponding to the first type and the first submersion position by referring to depth information in which a depth is associated with a pair of a type and a submersion position.

### CROSS-REFERENCE TO RELATED APPLICATION

This application is a continuation application of International Application PCT/JP2021/035440 filed on Sep. 27, 2021 and designated the U.S., the entire contents of which are incorporated herein by reference.

### FIELD

The present specification relates to a water inundation depth determination technique.

### BACKGROUND

Information on the depth of water inundation is important for disaster prevention and mitigation activities against floods and inundation. More particularly, information about the flood depth distribution is important as a basis for determining which locations should be patrolled, which residents in which locations need evacuate, which locations need flood control activities, etc. Conventionally, an expert with knowledge of the land visually assesses the depth of inundation based on his or her knowledge of the pre-inundation conditions of the location.

Examples of the related art include: [Patent Document 1] Japanese Laid-open Patent Publication No. 2007-046918; and [Patent Document 2] Japanese Laid-open Patent Publication No. 2018-132504.

### SUMMARY

According to an aspect of the embodiments, there is provided a non-transitory computer-readable recording medium storing a water inundation depth determination program for causing a computer to execute processing including: detecting a first type of a target and a first submersion position of the target included in a first captured image; and outputting a first submersion depth corresponding to the first type and the first submersion position by referring to depth information in which a depth is associated with a pair of a type and a submersion position.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of the configuration of a determination apparatus 10 according to the present embodiment.

FIG. 2 is a diagram illustrating an example of a captured image according to the present embodiment.

FIG. 3 is a diagram illustrating an example of a depth information table 123 according to the present embodiment.

FIG. 4 is a diagram illustrating an example of a submersion depth output according to the present embodiment.

FIG. 5 is a flowchart illustrating an example of the flow of the submersion depth determination process according to the present embodiment.

FIG. 6 is a diagram illustrating an example of a hardware configuration of the determination apparatus 10 according to the present embodiment.

### DESCRIPTION OF EMBODIMENTS

However, it is difficult for the conventional system to determine the water inundation depth from an image obtained by capturing a situation in which water has been immersed in a case where there is no information on the normal state.

In one aspect, it is an object to output a submersion depth from a captured image even without information on a normal state.

Examples of a water inundation depth determination program, a water inundation depth determination device, and a water inundation depth determination method according to the present embodiment will be described in detail below with reference to the drawings. The present embodiment is not limited to the examples herein. The embodiments may be combined as appropriate within a consistent range.

### Functional Configuration of Determination Device 10

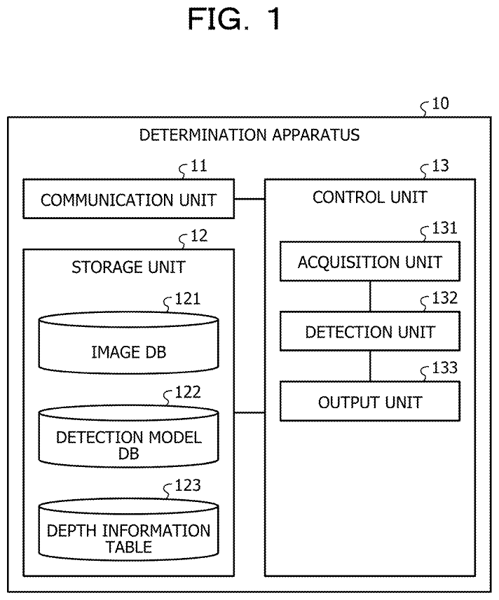

A functional configuration of a determination apparatus 10 according to the present embodiment will be described with reference to FIG. 1. FIG. 1 is a block diagram illustrating a configuration example of a determination device 10. As illustrated in FIG. 1, the determination device 10 includes a communication unit 11, a storage unit 12, and a control unit 13.

The communication unit 11 is a processing unit that controls communication with another information processing apparatus.

The storage unit 12 is a storage device that stores various data and programs executed by the control unit 13. The storage unit 12 stores an image database (DB) 121, a detection model DB 122, a depth information table 123, and the like.

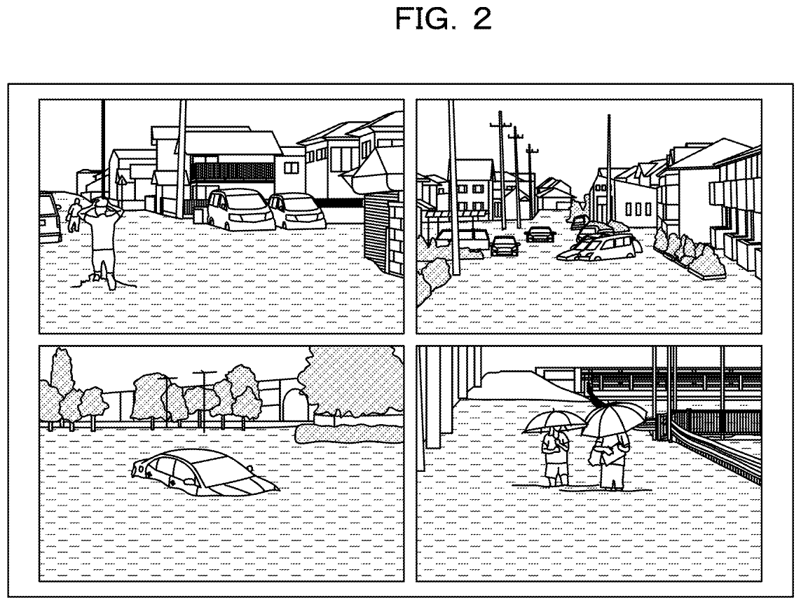

The image DB 121 stores an image obtained by capturing the flood situation. FIG. 2 is a diagram illustrating an example of a captured image according to the present embodiment. The captured image illustrated in FIG. 2 may be an image captured by a camera device, a smartphone having a camera function, or the like. The captured image may be an image captured by a resident in the flood area and uploaded on the Internet via a social networking service (SNS).

The detection model DB 122 stores: parameters for constructing a machine learning model, which is generated by machine learning using captured images as feature amounts and a type of a target included in the captured image as a correct label, and a plurality of pieces of training data for the model. Here, the type of the target may be, for example, an upright person, a squatting person, a sitting person, a vehicle, a building, a utility pole, or the like.

The detection model DB 122 stores: parameters for constructing a machine learning model, which is generated by machine learning using a target included in a captured image as a feature amount and a water inundation position of the target as a correct label, and a plurality of pieces of training data for the model. Here, the water inundation position of the target may be, for example, any of below the knee, above the knee, up to the waist, and up to the shoulder when the type of the target is an upright person, and up to the waist or up to the shoulder when the type of the target is a squatting person or a sitting person. For example, the water inundation position of the target may be, when the type of the target is a vehicle, any of up to a tire, up to a window, and water inundation, and when the type of the target is a building, any of under a floor, on a floor, up to a first floor, and up to a second floor. For example, the water inundation position of the target may be, when the type of the target is a utility pole (may be referred to as “telephone pole”, “light pole”, and the like), any of a place-name/land-number display, a pillar advertisement (i.e., an advertisement mounted on the body of a utility pole in a position relatively close to the pedestrian's eye level), and a hanging advertisement (i.e., an advertisement listed in a relatively high position, popping out from the side of a utility pole.). The model may be generated for each type of target.

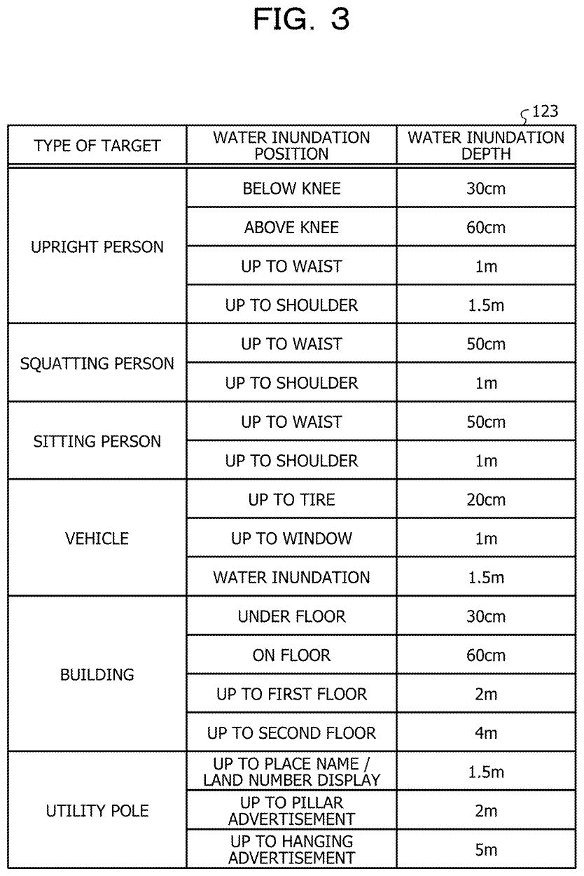

The depth information table 123 stores information in which a depth is associated with a combination of a type of a target and a water inundation position. For example, the depth information table 123 may store information that includes: a type of a target, a water inundation position, and a water inundation depth. FIG. 3 is a diagram illustrating an example of the depth information table 123 according to the present embodiment. As illustrated in FIG. 3, for example, a type of a target, a water inundation position, and a water inundation depth are set in the depth information table 123 in association with each other. For example, the depth information table 123 illustrated in FIG. 3 indicates that, in a case where the type of the target included in the captured image is an upright person, the water inundation depth is 30 cm when the water is immersed to the below-knee portion. The determination device 10 may retrieve the submersion depth by referring to the depth information table 123 using, as search keys, the type of the target and the submersion position detected from the captured image, for example.

The depth information table 123 illustrated in FIG. 3 is merely an example, and the setting values are not limited to the example illustrated in FIG. 3. The depth information table 123 may be generated by collecting captured images of submersion situations that occurred in the past, detecting the type of target and the submersion position from the captured images using a machine learning model, and associating the actual submersion depth with a combination of the detected type of target and submersion position.

The above mentioned information stored in the storage unit 12 is merely an example, and the storage unit 12 may store various other information in addition to the above mentioned information.

The control unit 13 is a processing unit that controls whole of the entire determination device 10, and includes an acquisition unit 131, a detection unit 132, and an output unit 133.

The acquisition unit 131 acquires an image obtained by capturing the flood situation. For example, the acquiring unit 131 collects captured images uploaded on the Internet via an SNS or the like, and stores the captured images in the image DB 121. The captured image may be collected for each region or time zone in which water inundation occurs.

The detection unit 132 detects the type of the target and the water inundation position included in the captured image acquired by the acquisition unit 131. For example, the detection unit 132 may detect the type of the target by inputting the captured image to a machine learning model, which is a model such as a neural network model trained using captured images as feature amounts and respective types of targets included in the captured images as correct labels. For example, the detection unit 132 may detect the water inundation position of the target by inputting the target included in the captured image to a machine learning model, which is a model such as a neural network model generated using the respective targets included in the captured images as feature amounts and the water inundation positions of the respective targets as correct labels.

The output unit 133 refers to the depth information table 123 using, as search keys, the type of the target and the water inundation position detected by the detection unit 132, and retrieves and outputs the water inundation depth. That is, the output unit 133 retrieves the water inundation depth from the depth information table 123 by using, as search keys, the type of the target and the water inundation position detected by the detection unit 132.

The output of the submersion depth by the output unit 133 may be performed via an output device such as a display device connected to the determination device 10, for example.

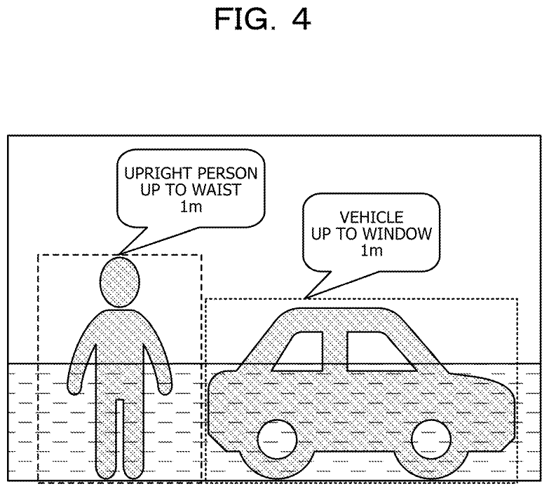

FIG. 4 is a diagram illustrating an example of the submersion depth output according to the present embodiment. As illustrated in FIG. 4, for example, the output unit 133 may enclose the detected target in the captured image with a bounding box, and output the target in association with the type, the submersion position, and the submersion depth of the target.

### Flow of Processing

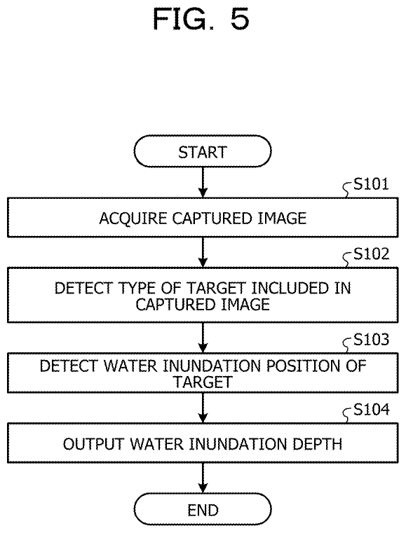

Next, a flow of the submersion depth determination process by the determination device 10 will be described with reference to FIG. 5. FIG. 5 is a flowchart illustrating an example of the flow of the submersion depth determination process according to the present embodiment.

First, as illustrated in FIG. 5, the determination device 10 acquires an image obtained by capturing a flood situation (step S101). The captured image may be acquired in step S101 by acquiring the captured image uploaded on the Internet via the SNS or the like in real time, or by acquiring the captured image collected in advance and stored in the image DB 121.

Next, the determination device 10 detects the type of the target included in the captured image by inputting the captured image acquired in step S101 to the machine learning model (step S102). The machine learning model used in step S102 may be a machine learning model generated by machine learning using captured images as feature amounts and using the type of respective targets included in the captured images as correct labels.

Next, the determination device 10 detects the water inundation position of the target included in the captured image by inputting the target included in the captured image acquired in step S101 to the machine learning model (step S103). The machine learning model used in step S103 may be a machine learning model generated by machine learning using respective targets included in the captured images as feature amounts and water inundation positions of the respective targets as correct labels.

Next, the determination device 10 refers to the depth information table 123 using, as search keys, the type of the target and the water inundation position acquired in each of steps S103 and S104, and retrieves and outputs the water inundation depth (step S104). After the execution of step S104, the submersion depth determination process illustrated in FIG. 5 is completed.

### Effects

As described above, the determination device 10 detects the first type of the target included in the first captured image and the first submersion position of the target, refers to the depth information in which the depth is associated with the combination of the type and the submersion position, and outputs the first submersion depth corresponding to the first type and the first submersion position.

In this way, the determination device 10 detects the type of the target and the submersion position included in the image obtained by imaging the submersion situation, and outputs the submersion depth with reference to the depth information associated with the combination of the type and the submersion position. Thus, it allows the determination device 10 to output the submersion depth from the captured image even without information on the normal state.

The detecting of the first type by the determination apparatus 10 may include detecting the first type by inputting the first captured image to a first machine learning model, which is a model such as a neural network model trained using captured images as feature amounts and types of respective targets in the captured images as correct labels.

Thus, it allows the determination device 10 to accurately detect the type of the target included in the image obtained by capturing the flood situation.

The detecting of the first water inundation position by the determination device 10 may include detecting the first water inundation position by inputting the target included in the first captured image to a second machine learning model, which is a model such as a neural network model trained using the respective targets included in the captured images as feature amounts and water inundation positions of the respective targets as correct labels.

Thus, it allows the determination device 10 to accurately detect the water inundation position of the target included in the image obtained by capturing the water inundation situation.

The detecting of the first type by the determination device 10 may include detecting, as the first type, at least any one of an upright person, a squatting person, a sitting person, a vehicle, a building, or a utility pole.

Thus, it allows the determination device 10 to detect the types of various objects included in the image obtained by capturing the submersion situation and output the submersion depth based on the detected types.

The detecting of the first water inundation position by the determination device 10 may include detecting, as the first water inundation position, at least any one of: when the first type is an upright person, below the knee, above the knee, to the waist, and to the shoulder; when the first type is a squatting person or a sitting person, to the waist or shoulder; when the first type is a vehicle, to the tire, to the window, and to submersion; when the first type is a building, to under the floor, above the floor, to the first floor, and to the second floor; and when the first type is a utility pole, to a place name/land number display, to a pillar advertisement, and to a hanging advertisement.

Thus, it allows the determination device 10 to detect the water inundation positions of various objects included in the image obtained by imaging the water inundation situation and output the water inundation depth based on the detected water inundation positions.

### System

The processing procedures, the control procedures, the specific names, and the information including various data and parameters described in the above document and the drawings may be changed unless otherwise specified. The specific examples, distributions, numerical values, and the like described in the embodiments are merely examples, and may be changed if required.

In addition, a specific form of distribution or integration of the components of the determination device 10 is not limited to the illustrated form. For example, the detection unit 132 of the determination device 10 may be distributed to a plurality of processing units, or the detection unit 132 and the output unit 133 of the determination device 10 may be integrated into one processing unit. That is, all or some of the constituent elements may be functionally or physically distributed or integrated in arbitrary units according to various loads or use conditions. Furthermore, all or any part of the processing functions of the devices may be realized by a CPU and a program analyzed and executed by the CPU, or may be realized as hardware by wired logic.

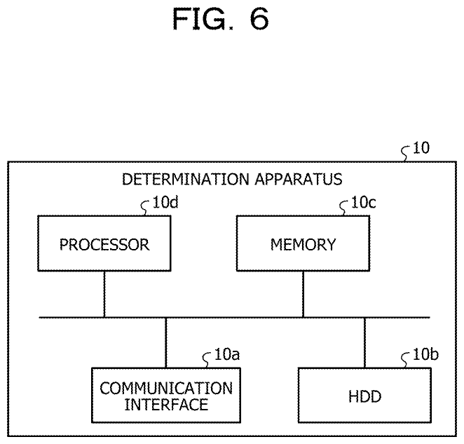

FIG. 6 is a diagram illustrating an example of a hardware configuration of the determination apparatus 10 according to the present embodiment. As illustrated in FIG. 6, the determination apparatus 10 includes a communication interface 10a, a hard disk drive (HDD) 10b, a memory 10c, and a processor 10d. The units illustrated in FIG. 6 are connected to each other via a bus or the like.

The communication interface 10a is a network interface card or the like, and communicates with other information processing device. The HDD 10b stores programs and date for operating the functions illustrated in FIG. 1 and the like.

The processor 10d is a central processing unit, a micro processing unit, a graphics processing unit, or the like. The processor 10d may be realized by integrated circuits such as an application specific integrated circuit (ASIC) and a field programmable gate array (FPGA). The processor 10d is a hardware circuit that executes processing for realizing each function described in FIG. 1 and the like by loading a program RAM for executing the same processing as each processing unit illustrated in FIG. 1 and the like from HDD 10b and the like and deploying the program in the memory 10c.

The determination apparatus 10 may also realize the same functions as those of the above-described embodiments by loading the above-described program from a recording medium by a medium reading apparatus and executing the loaded program. The program according to the other embodiments is not limited to being executed by the determination apparatus 10. For example, the above-described embodiment may be similarly applied to a case where another information processing apparatus executes a program or a case where the information processing apparatus and the other information processing apparatus execute a program in cooperation with each other.

The program may be distributed via a network such as the Internet. The program may be recorded in a computer-readable recording medium, such as a hard disk, a flexible disk (FD), a compact disc read-only memory (CD-ROM), a magneto-optical (MO) disk, or a digital versatile disc (DVD), and may be executed by being loaded from the recording medium by the computer such as an information processing apparatus.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a water inundation depth determination program for causing a computer to execute processing comprising:
detecting a first type of a target and a first submersion position of the target included in a first captured image; and
outputting a first submersion depth corresponding to the first type and the first submersion position by referring to depth information in which a depth is associated with a pair of a type and a submersion position.

2. The non-transitory computer-readable recording medium according to claim 1, wherein
the detecting of the first type includes detecting the first type by inputting the first captured image to a first machine learning model generated by machine learning using the captured image as a feature amount and using a correct label as a type.

3. The non-transitory computer-readable recording medium according to claim 1, wherein
the detecting of the first water inundation position includes detecting the first water inundation position by inputting the target included in the first captured image to a second machine learning model generated by machine learning using the target included in the captured image as a feature amount and the water inundation position as a correct label.

4. The non-transitory computer-readable recording medium according to claim 1, wherein
the detecting of the first type includes a process of detecting at least one of an upright person, a squatting person, a sitting person, a vehicle, a building, and a utility pole as the first type.

5. The non-transitory computer-readable recording medium according to claim 4, wherein
the detecting of the first submersion position includes detecting at least one of a below-knee position, an above-knee position, a waist position, and a shoulder position of the upright person, a waist position or a shoulder position of the squatting person or the sitting person, a tire position, a window position, and submersion of the vehicle, an underfloor position, a floor position, a first floor position, and a second floor position of the building, and a place name and land number display, a pillar advertisement, and a hanging advertisement of the utility pole as the first submersion position.

6. A water inundation depth determination device comprising:
a memory; and
a processor coupled to the memory, the processor being configured to perform processing comprising:
detecting a first type of a target and a first submersion position of the target included in a first captured image; and
outputting a first submersion depth corresponding to the first type and the first submersion position by referring to depth information in which a depth is associated with a pair of a type and a submersion position.

7. A water inundation depth determination method implemented by a computer, the method comprising:
detecting a first type of a target and a first submersion position of the target included in a first captured image; and
outputting a first submersion depth corresponding to the first type and the first submersion position by referring to depth information in which a depth is associated with a pair of a type and a submersion position.
